(19) United States
(12) Patent Application Publication
(10) Pub. No.: US 2006/0246266 A1
(43) Pub. Date: Nov. 2, 2006

(54) Ultra thin graphics and methods

(75) Inventor: Kenneth E. Hall, North Branch, MN (US)

Correspondence Address: KAGAN BINDER, PLLC, SUITE 200, MAPLE ISLAND BUILDING, 221 MAIN STREET NORTH, STILLWATER, MN, 55082, US

(73) Assignee: Modernistic, Inc.

(21) Appl. No.: 11/398,274

(22) Filed: Apr. 5, 2006

Related U.S. Application Data
(60) Provisional application No. 60/676,015, filed on Apr. 29, 2005.

(51) Int. Cl. B41M 5/00

(52) U.S. Cl. 428/195.1

(57) ABSTRACT

A transferable image for water-slidable application to surfaces is provided comprising a water-absorbing Porous Backing Sheet; a water-soluble Resin Coating coated on the water-absorbing Porous Backing Sheet; a base layer on the water-soluble Resin Coating; and a plurality of ink layers on the base layer, at least one of the ink layers being translucent or transparent and applied in overlapping fashion in a manner to provide a color effect. In preferred embodiments, a transfer premask is provided wherein the transfer premask is substantially no wider than about 0.25 inches than the perimeter of the image shape.

This application claims the benefit of U.S. Provisional Application Ser. No. 60/676,015, filed Apr. 29, 2005, entitled “ULTRA THIN GRAPHICS AND METHODS,” which application is incorporated herein by reference in its entirety.

### FIELD OF THE INVENTION

The invention relates to graphic images. More specifically, the invention relates to ultra thin graphic images that can be applied in slidable format.

### BACKGROUND

Image graphics have long been applied to substrates by using a slidable delivery format. Examples of such image graphics are the familiar decals that have been applied to model airplanes and the like. Another application of the slidable delivery technology is in the temporary tattoo product category. These slidable application technologies have heretofore only been used for relatively straightforward graphic applications, using traditional printing technologies. The graphics have been difficult to apply with precision without wrinkling the image.

Moore, et al., U.S. Pat. No. 6,074,721, disclose mass production of decals, wherein the design is applied directly to the water soluble slip layer, which slip layer coats a porous backing paper, and a clear spot coating is applied between the ink and the pressure sensitive adhesive to prevent the surface of the decal from becoming sticky to the touch. Again, such a decal is designed to be mass produced in a factory using a high speed lithographic press.

U.S. Pat. No. 6,623,817 to Yang et. al. disclose inkjet printed graphics to a receiving surface comprising in combination (1) a water-absorbing porous back sheet (2) a water-soluble resin coating applied to the backing sheet, (3) a waterproof film forming resin coating, and (4) a waterproof inkjet receptive coating. The combination of the foregoing results in a high quality printing and easy transfer to a receiving surface after soaking in water.

U.S. Pat. No. 6,039,822 to Heyworth, et al. describes a decal applying process using direct screen printing. In this process, decals are applied to products having rough textured surfaces, such as products made from thermoplastic resins, leather, or synthetic leather. The decals applied to the products contain detailed multicolor graphic images made from a four color printing process. The decal applying process includes applying a first clear ink layer directly to the substrate surface, applying a water-release slide-off decal on top of the first clear ink layer, and applying a second clear ink layer over the applied decal to firmly bond the decal to the substrate surface. The two ink layers encapsulate the decal on the substrate surface, maintaining the integrity of the decal.

### SUMMARY OF THE INVENTION

In conventional custom paint procedures, intricate designs having remarkable color effects are achieved only by applying paint by hand or spray painting with repeated hand applied masking techniques. It was previously thought that color effects could only be achieved through the laborious process of hand application of a large number of paints and clear-coats directly to the article to be painted. As a result, a cottage industry of specialized paint shops has developed, with custom paint artisans establishing a world-wide reputation for the color effects that they can achieve through their highly skilled work. Surprisingly, using printing processes capable of mass production, highly detailed images can be prepared in accordance with the present invention that have the appearance of images that heretofore could only be applied directly to a substrate, such as a motorcycle or automobile, through laborious custom paint procedures.

The present invention provides unique image graphic delivery for high quality images to achieve color effects not heretofore realizable. In one aspect of the present invention, a transferable image for water-slidable application to surfaces is provided comprising a water-absorbing Porous Backing Sheet that has been coated with a water-soluble Resin Coating. A plurality of ink layers is located on the water-soluble Resin Coating, at least one of the ink layers being translucent or transparent and applied in overlapping fashion in a manner to provide a color effect.

For purposes of the present invention, a “color effect” is defined as the visual impression afforded to the viewer by observing an interaction between two or more overlapping layers of ink. The interaction may be manifested in the appearance of depth, flop, shimmer, pearlescence, metallic effect, shadowing effect, color change based on angle of view and/or ambient light intensity, and flashy looks colloquially termed as “bling-bling,” or other such optical effects as will now be apparent to the skilled artisan. The final graphic image provides the appearance of custom paint details, with the advantage of the capability to mass produce the desired image and apply the image at any location, such as factory settings or in custom automobile or motorcycle shops.

In another aspect of the present invention, transferable images for water-slidable application to surfaces are provided having exceptional ease and precision in transfer are provided. In this aspect, a transferable image construction is provided wherein a water-absorbing Porous Backing Sheet is coated with a water-soluble Resin Coating. At least one ink layer is provided on the water-soluble Resin Coating, and a transparent top layer is additionally provided that completely overcoats the ink layer and defines an image shape having a perimeter. Finally, a transfer premask is provided that completely overcoats the transparent top layer, wherein the transfer premask is substantially no wider than about 0.25 inches than the transparent top layer at the perimeter of the image shape. This image transfer construction comprising the transfer premask provides an image that can be readily transferred to a target substrate with precision and with high integrity of the image. The transfer premask provides stability to the image for effective transfer. Because the transfer premask is substantially not more than about 0.25 inches wider than the transparent top layer at the perimeter of the image shape, the water that is carried with the image during transfer can be efficiently and substantially removed by careful squeegee techniques without damaging the image. Additional optional features can be provided to assist or enhance ease of placement of the transferable image to a target substrate in an easy to use system. Examples of such features include incorporating transfer premask perimeter structures configured to propagate a tear upon removal from the transferable image, tab structures to assist in removal of the transfer premask from the transferable image, locator markers to assist in accurate placement of the transferable image to a target substrate, and combinations thereof.

In addition to advantages discussed above, the present transferable image system provides unique advantages. In one aspect, the final image on the substrate is superior to that which can be achieved by merely printing an image on top of a conventional adhesive coated polymer base film (such as a vinyl film), because the thickness of the adhesive coated polymer films introduces deformities in the image that are readily visible to the discerning viewer. Additionally, conventional vinyl base films that are often used for providing a transferable image to a target substrate have typical thicknesses of at least about 2 mils, and often 4 mils, before the image is printed on the vinyl, and additionally comprise a pressure sensitive adhesive layer that is 1 mil thick. Such vinyl films present a very noticeable and an objectionable edge due to the 3 to 5 mil or greater profile of the product that is adhered to the target substrate. In contrast, the image of the present invention when in place on the target substrate preferably has a total thickness (i.e. including top and base layers, if present, and all ink layers) of less than about 2 mils, more preferably a total thickness of less than about 1.5 mils. Particularly preferred embodiments of the present invention have a total thickness of less than about 0.8 mils, and more preferably a total thickness of less than about 0.5 mils.

In use, the transferable image as described herein is soaked in clean water for a time sufficient to render the image and accompanying base layers readily slidably separable from the Resin Coating coated Porous Backing Sheet. The image is then separated from the Porous Backing Sheet and positioned on the target substrate. While not being bound by theory, it is believed that a portion of the Resin Coating remains associated with the bottom surface of the transferred image, and assists in adhering the image to the target substrate. Water associated with the transferred image, particularly under the image, is then carefully removed to assist in adhering the image to the targeted substrate. Preferably the water is removed by use of a flexible squeegee, such as Plastic Body Filler Spreader or Squeegee made by Bondo and designated Bondo # 357. This type of Squeegee is rigid enough to force the water out from under the graphic, and flexible enough to not wrinkle, fold or cause some type of surface impression on the graphic. The image is then allowed to fully dry, or preferably is heated to assist in removal of water. In a preferred embodiment, the substrate having the image applied thereto is exposed to heat in a static or ramped increase in heat, most preferably in a range of from about 100 to about 175 degrees F. to allow moisture to wick out from under the graphic and create the desired bond.

The present transferable image system additionally provides readily shippable detailed, high quality images that can be easily applied to any substrate on location if desired. For example the images as described herein can be designed for application to signboard or backlit sign substrates and cheaply shipped to distant locations for application to commodity stock material closer to the location of actual use, thereby substantially reducing shipping costs.

### BRIEF DESCRIPTION OF THE DRAWING

The accompanying drawings, which are incorporated in and constitute a part of this application, illustrate several aspects of the invention and together with a description of the embodiments serve to explain the principles of the invention.

### BRIEF DESCRIPTION OF THE DRAWINGS

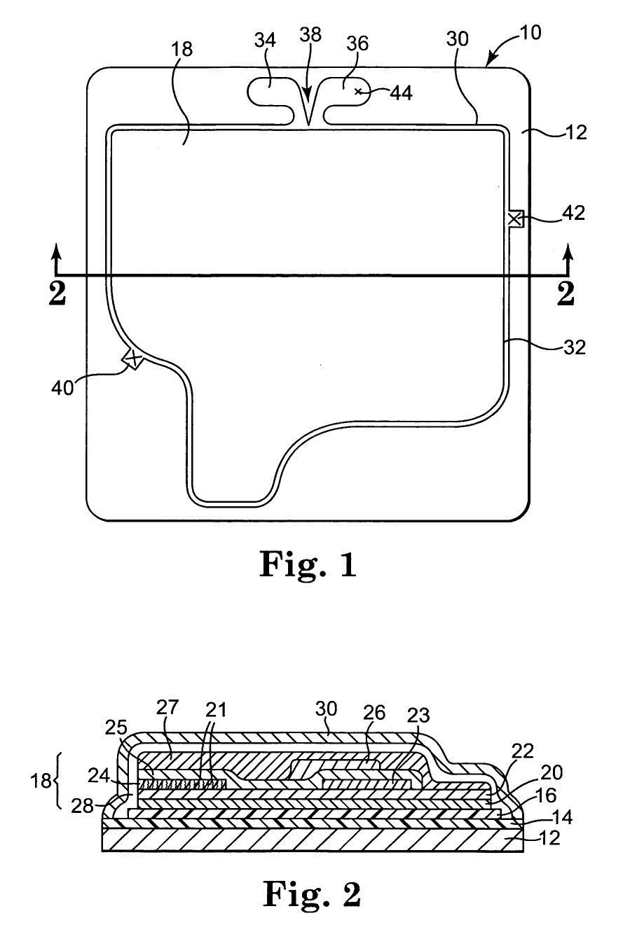

FIG. 1 is a plan view of a transferable image for water-slidable application of the present invention.

FIG. 2 is a cross sectional view of a transferable image for water-slidable application of FIG. 1 taken along line 2-2.

### DETAILED DESCRIPTION

Turning now to the drawings, wherein like numbers represent like parts and parts are not drawn to scale, FIG. 1 is plan view of a transferable image construction 10 for water-slidable application to a target substrate. FIG. 2 is a cross sectional view transferable image construction 10 of FIG. 1 taken along line 2-2.

In the transferable image construction 10, an image 18 is provided on a water-absorbing Porous Backing Sheet 12, which is provided with a coating of water-soluble Resin Coating layer 14 thereon. Optional transfer premask 30 is provided over the top of image 18 to assist in transfer of image 18 to the target substrate.

More specifically in a preferred embodiment of the present invention, a water-absorbing Porous Backing Sheet 12 is provided with a coating of water-soluble Resin Coating layer 14 thereon. The water-absorbing Porous Backing Sheet may be any appropriate substrate material for support of the transferable image construction prior to removal by water-slide operation. Examples of materials suitable for use as water-absorbing Porous Backing Sheets include book papers, commercial printing papers, uncoated or coated groundwood papers, paperboard, specialty kraft papers, converted papers, non-resin coated photographic background paper, clay-coated cardboard paper, or various paperboard alternatives. Preferably, the water-absorbing Porous Backing Sheet is dimensionally stable under printing conditions, i.e. does not change dimension under printing conditions such that registration cannot be maintained under multiple printing and drying passes.

The water-soluble Resin Coating layer 14 performs the function of providing a slippery surface upon exposure of the transferable image construction 10 to water, to assist in removal of the image from water-absorbing Porous Backing Sheet 12. Additionally, water-soluble Resin Coating layer 14 performs the function of providing an adhesive component that assists in holding the transferred image to the target substrate after drying.

The water-soluble Resin Coating layer 14 is preferably a water-soluble polymer, either natural or synthetic type. Examples of such polymers include natural polymers such as gelatin, gelatin extenders, gelatin derivatives, graft polymers of gelatin other natural polymers and synthetic hydrophilic colloidal homo-polymer and co-polymer, and aqueous dispersions of hydrophobic homo-polymer and co-polymer. Gelatin includes acid or base treated cow bone gelatin, pigskin gelatin and fish gelatin. Other natural polymers include Arabic gum, albumin and casein, sugar derivatives such as cellulose derivatives (e.g., hydroxyethyl cellulose, carboxymethyl cellulose, cellulose sulfate and cellulose acetate butyrate), sodium alginate, and starch derivatives. Additional examples of such polymers include synthetic polymers such as polyvinyl acetate butyrate, sodium alginate, and starch derivatives, polyvinyl alcohol (PVOH), polyvinyl alcohol partial acetyl, polyethylene glycol (PEG), poly (2-ethyl-2-oxazoline) (PEOX), polyamides, acrylate derivatives (e.g., polyacrylic acid, polymethacrylic acid, polyacrylamide), polyvinyl imidazole, polyvinylpyrazole, and positively charged polyurethane.

Dispersions using hydrophobic polymers such as polyvinylidone chloride, polyethylacrylate, or hard thermoplastic acrylic co-polymers may be applicable, as well. Commercially available “Waterslide decal paper” can also be used for this purpose. For example, Tullis Russell decal paper, manufactured by the Brittain Paper Mills, located at Commercial Road, Hanley, Stock-on-Trent STI 3QS, U. K., is applicable. One side of the Tullis Russell decal paper is coated with polyvinyl alcohol (PVA).

Base layer 16 is located on water-soluble Resin Coating layer 14 to provide transfer support for image 18. Preferably, base layer 16 is formed from a waterproof film-forming resin capable of providing a tough, thin film which carries image 18 from the carrier sheet after soaking in water and easily transferring to a receiving surface, and additionally provides a surface for bonding or adhesion of image 18 to the target substrate.

Base layer 16 preferably is provided in a thickness of less than about 0.3 mils, more preferably less than about 0.2 mils, and most preferably less than about 0.1 mils. In embodiments of the present invention, it is generally desired to have the base layer be sufficiently thin that the layer itself cannot be measured with a micrometer, but instead must be measured by photomicroscopy or by calculation based on coating weight or coating application technique. In embodiments of the invention, the base layer is at least about 0.0001 mils thick. In another embodiment of the invention, the base layer is at least about 0.001 mils thick. In another embodiment of the invention, the base layer is at least about 0.01 mils thick.

Preferably, base layer 16 has dimensional stability, i.e. does not change dimension under conditions of use to a degree that would adversely affect the appearance or adhesion of the image. Preferably, base layer 16 is inert to conventional solvents, such as water, alcohol, aldehydes and ketones. Preferably, base layer 16 is formed from a thermoplastic polymer. Examples of suitable film-forming resins include polymethacrylate, polymethyl methacrylate, polybutyl methacrylate, polystyrene, polystyrene butadiene, polyethylene urethane, polyurethane acrylics, polyamide acrylics, nitrocellulose, acrylic nitrocellulose, cellulose acetate, cellulose acetate butyrate, cellulose acetate propionate, cellulose ether, polyvinyl acrylics, alkyd resin, acrylic alkyd resin, epoxide, epoxy novolac resin, epoxy ester resin, melamine resin, acrylic melamine resin, melamine formaldehyde resin, urea formaldehyde resin, phenolics, polyvinyl, polyvinyl ester, polyvinyl acetate, polyvinyl chloride, polyvinyl chloride acetate, and polyvinyl alcohol.

Base layer 16 may be transparent, translucent or opaque. In a preferred embodiment, base layer 16 is transparent or translucent in order to facilitate color blending and interaction of image 18 with the color of the target substrate.

Optionally, base layer 16 may be provided with a coating or treatment to render the surface thereof more receptive to inks. Coatings for this purpose, such as inkjet receptive coatings, are well known in the printing industry.

Image 18 as shown preferably comprises a plurality of ink layers 20, 22, 23, 24, 25, 26 and 27. For purposes of the present invention, a layer in this region of the construction will be identified as an ink layer, even though it may be transparent. Identifying a transparent layer as an ink layer in this context is appropriate, because the layer preferably is prepared using the same base layer forming material but without tinting or coloration, and additionally is applied in the same manner as the translucent or opaque inks. One or more of the ink layers are translucent or transparent, as discussed above. In a preferred embodiment, all of the ink layers are translucent or transparent. As may be observed in FIG. 2, ink layers are provided in relative overlapping manner to provide the desired color effect and total image appearance. For example, ink layer 20 preferably is a translucent ink of one color, and ink layer 22 is a transparent ink that is coextensive with ink layer 20. Ink layers 23 and 24 are discrete translucent inks that provide a different color effect in those regions of image 18 as observed by the viewer. As shown, ink layer 24 comprises metal flakes 21 to impart a shimmer or sparkle color effect in that region of image 18. Alternative additives, such as special reflective, prismatic or optically apparent powders, flakes, particles and the like can be incorporated in the ink as will now be apparent to the skilled artisan. The powders, flakes, particles and the like can be prepared from metal, plastic, metallized plastic, mineral and other such materials now apparent to the skilled artisan. Ink layer 25 can, for example, be a translucent ink layer that completely overlaps ink layers 23 and 24, but is not coextensive with ink layer 22. Ink layer 27 can, for example, be a transparent ink that substantially overlaps all of the preceding ink layers. In a preferred embodiment, image 18 comprises from about 3 to about 12 ink layers. In another preferred embodiment, the ink layer adjacent to the water-soluble Resin Coating is opaque. Preferably, at least one of the ink layers comprises prismatic powders and/or metal flakes. Various color effects can be achieved in part by providing inks in varying thicknesses of ink layers, varying color densities and varying solids content of the ink. In an alternate embodiment, all of the ink layers can be substantially coextensive.

The ink layers of the image can be applied by any suitable mass production printing system. In a particularly preferred embodiment, the ink layers are applied by a screen print process. In another preferred embodiment, the ink layers are applied by a digital printing process. In certain embodiments, the ink layers can be applied by a printing process selected from ink jet, thermo, piezo, flexographic and lithographic printing processes. Optionally, the ink layers can be applied by a plurality of sequential different printing processes. For example, a first layer or sequence of ink layers could by applied by a screen printing process, followed by application of one or more layers by an alternative process such as an ink jet process.

The resulting image 18 is then preferably overcoated with a transparent top layer 28, which completely overcoats and, together with bottom layer 16, encases and protects the image 18. This encased image defines an image shape having a perimeter 32. Transparent top layer 28 can be made from materials such as previously described in the description of materials for bottom layer 16. In a preferred embodiment, the materials used for transparent top layer 28 are the same or substantially the same as the materials for bottom layer 16. Transparent top layer 28 can alternatively be translucent, provided that the image 18 is visible through transparent top layer 28.

The use of a premask is highly preferred to provide proper placement of image 18 on the target substrate. Optional transfer premask 30 completely overcoats the transparent top layer 28 in a manner so that transfer premask 30 is substantially no wider than about 0.25 inches, and preferably substantially no wider than about 0.125 inches, than the transparent top layer 28 at the perimeter 32 of the image shape. As noted above, a wider transfer premask protects and assists in transfer of the image. The narrow margin of overextension of the premask, as opposed to a larger overextension, facilitates the removal of water that is carried with the image during transfer by squeegee techniques and/or drying operations as discussed above. In certain image configurations, portions of the design may lack image in the center of the image shape, or the image may extend in closely arrayed elongated portions, such as in the tongues of a flame image. In such configurations, connective transfer premask elements may assist in proper relative positioning of the extended portions of the image. In such image shapes, it is particularly desirable to leave openings in the transfer premask at locations where there is no image underlying the premask. Such gaps in the transfer premask surprisingly facilitate egress of water after placement of the image on the target substrate.

Transfer premask 30 is a thin, flexible overcoat with sufficient integrity to provide handleability to image 18 during transfer. Transfer premask 30 additionally is removably adhered to transparent top layer 28, such that, after application of image 18 to the target substrate and at least partial drying of image 18 in place on the target substrate, transfer premask 30 can be peeled off of image 18, thereby providing an extremely thin graphic image 18 on the substrate.

Preferably, transfer premask 30 is transparent or translucent, so that image 18 can be seen through transfer premask 30, thereby assisting in proper location of image 18 on the target substrate.

It has surprisingly been found that the dimensions of the transfer premask 30 have substantial impact on the ease of use of the premask in removal of water after initial placement of image 18 on the target substrate. In addition to the dimensions recited above with respect to size relative to the perimeter 32 of image 18, it has been found that the thickness of transfer premask preferably should not be the same for all sizes of images to be transferred. Thus, transfer premask 30 preferably has a thickness of from about 1 to about 1.8 mils when image 18 has an area of less than about 650 cm². Similarly, transfer premask 30 preferably has a thickness of from about 1.8 to about 2.2 mils when image 18 has an area of from about 650 cm² to about 3500 cm², and transfer premask 30 preferably has a thickness of from about 2.5 to about 3 mils when image 18 has a one sided length of greater than about 120 cm.

In a preferred embodiment transfer premask 30 is provided with tab structures 34 and 36 to assist in removal of transfer premask 30 from image 18 after placement on the target substrate. The addition of tabs 34 and 36 is contemplated as expected exceptions in the above recitation of size of the transfer premask 30 relative to the perimeter 32 of image 18, and in part the reason why the term “substantially” is used in this recitation.

In another preferred embodiment, transfer premask 30 is provided with perimeter structure 38 configured to propagate a tear upon removal of the transfer premask 30 from the image 18. As shown, tabs 34 and 36 can be pulled in opposite directions, thereby propagating a tear down the middle of transfer premask 30 and eliminating the need to remove transfer premask 30 in a single piece. This embodiment is particularly advantageous in embodiments where the image 18 has an area greater than about 1300 cm².

In yet another preferred embodiment, transfer premask 30 is provided with locator markers 40, 42 and 44 to assist in accurate placement of the transferable image to a target substrate. Locator markers, as shown, are visible cross-hair markings in transparent premask 30. Other visible locator marking may alternatively be used, such as dots, circles, triangles and the like as will be readily apparent to the skilled artisan. Alternatively, locator markers can be visible under black light conditions, or other suitable viewing conditions. Alternative locator markers can be in the form of physical projections or indentations in the perimeter of transfer premask 30, or any other position indicating system as will now be apparent to the skilled artisan. The locator markers can be used to position the image 18, together with transfer premask 30, in registration with predetermined position coordinates on the target substrate. Optionally, the position coordinates are identified on the target substrate by temporary or permanent markings physically on the target substrate, or by illumination or other remote identification of desired position coordinates on the target substrate, such as by laser beam.

Optionally, after placement of image 18 on the target substrate, image 18 can be further overcoat with a transparent or translucent clear coat or varnish or similar overcoat to provide additional protection and uniform finish to the target substrate. The resulting imaged substrate surprisingly does not present the appearance of a substrate having an image adhered thereto, but rather has the appearance of a substrate having an image painted thereon. The image does not present an objectionable edge that would suggest inferior quality or mass production.

In a preferred embodiment of the present invention, the transferable image construction is free of pressure sensitive adhesive, both before and after transfer to the target substrate.

All percentages and ratios used herein are weight percentages and ratios unless otherwise indicated. All publications, patents and patent documents cited are fully incorporated by reference herein, as though individually incorporated by reference. Numerous characteristics and advantages of the invention meant to be described by this document have been set forth in the foregoing description. It is to be understood, however, that while particular forms or embodiments of the invention have been illustrated, various modifications, including modifications to shape, and arrangement of parts, and the like, can be made without departing from the spirit and scope of the invention.

1. A transferable image for water-slidable application to surfaces comprising:
a) a water-absorbing Porous Backing Sheet;
b) a water-soluble Resin Coating coated on the water-absorbing Porous Backing Sheet;
c) a base layer on the water-soluble Resin Coating; and
d) a plurality of ink layers on the base layer, at least one of the ink layers being translucent or transparent and applied in overlapping fashion in a manner to provide a color effect.

2. The transferable image of claim 1, wherein all of the ink layers are translucent or transparent.

3. The transferable image of claim 1, wherein the transferable image comprises from about 3 to about 12 ink layers.

4. The transferable image of claim 1, wherein the ink layer adjacent to the water-soluble Resin Coating is opaque.

5. The transferable image of claim 1, wherein at least one of the ink layers comprises prismatic powders and/or metal flakes.

6. The transferable image of claim 1, wherein the ink layers are applied by a screen print process.

7. The transferable image of claim 1, wherein the ink layers are applied by a digital printing process.

8. The transferable image of claim 1, wherein the ink layers are applied by a printing process selected from ink jet, thermo, piezo, flexographic, and lithographic printing processes.

9-10. (canceled)

11. A transferable image for water-slidable application to surfaces comprising:
1a) a water-absorbing Porous Backing Sheet;
b) a water-soluble Resin Coating coated on the water-absorbing Porous Backing Sheet;
c) a base layer on the water-soluble Resin Coating;
d) at least one ink layer on the base layer;
e) a transparent top layer completely overcoating the ink layer, thereby defining an image shape having a perimeter; and
f) a transfer premask completely overcoating the transparent top layer; wherein the transfer premask is substantially no wider than about 0.25 inches than the transparent top layer at the perimeter of the image shape.

12. The transferable image of claim 11, wherein the transfer premask is substantially no wider than about 0.125 inches than the transparent top layer at the perimeter of the image shape.

13. The transferable image of claim 11, wherein the transfer premask has a thickness of from about 1 to about 1.8 mils when the image shape has an area of less than about 650 cm².

14. The transferable image of claim 11, wherein the transfer premask has a thickness of from about 1.8 to about 2.2 mils when the image shape has an area of from about 650 cm² to about 3500 cm².

15. The transferable image of claim 11, wherein the transfer premask has a thickness of from about 2.5 to about 3 mils when the image shape has a one sided length of greater than about 120 cm.

16. The transferable image of claim 11, wherein the transfer premask is provided with perimeter structure configured to propagate a tear upon removal from the transferable image.

17. The transferable image of claim 11, wherein the transfer premask is provided with tab structures to assist in removal of the transfer premask from the transferable image.

18. The transferable image of claim 11, wherein the transfer premask is provided with locator markers to assist in accurate placement of the transferable image to a target substrate.

19. The transferable image of claim 11, wherein the ink layer comprises a plurality of ink layers, at least one of the ink layers being translucent or transparent and applied in overlapping fashion in a manner to provide a color effect.

20. The transferable image of claim 1, wherein the image as transferred, including any base layers has a thickness of less than about 2 mils.

21. An image in place on a substrate, said image
comprising a base layer and a plurality of ink layers on the base layer, at least one of the ink layers being translucent or transparent and applied in overlapping fashion in a manner to provide a color effect, the image having been applied to the substrate by water slide transfer from a water-absorbing Porous Backing Sheet having a water-soluble Resin Coating coated on the water-absorbing Porous Backing Sheet.

22. A method of transferring an image to a substrate, comprising
a) providing a transferable image of claim 1,
b) soaking the transferable image water for a time sufficient to render the image and accompanying base layers readily slidably separable from the Resin Coating coated Porous Backing Sheet;
c) separating the image from the Porous Backing Sheet and positioning the image on the substrate.
